(19) United States
(12) Patent Application Publication
(10) Pub. No.: US 2025/0341258 A1
(43) Pub. Date: Nov. 6, 2025

(54) VALVE DIAPHRAGM

(71) Applicant: GEMÜ Gebr. Müller Apparatebau GmbH & Co. Kommanditgesellschaft, Ingelfingen (DE)

(72) Inventors: Michael Klemt, Pfedelbach (DE); Thomas Esslinger, Pfedelbach (DE); Thomas Rüeck, Rosenberg (DE); Steffen Meinikheim, Ingelfingen (DE)

(21) Appl. No.: 18/870,017

(22) PCT Filed: May 17, 2023
(86) PCT No.: PCT/EP2023/063363

§ 371 Date: Nov. 27, 2024

(30) Foreign Application Priority Data
Jun. 10, 2022 (DE) 10 2022 114 721.5

(51) Int. Cl. F16K 7/12; F16K 25/00

(52) U.S. Cl. CPC F16K 7/12; F16K 25/005

(57) ABSTRACT

The invention relates to: a valve diaphragm (100) with a functional region (130), which is surrounded by an outer clamping region (120), wherein a wet-side surface (124), which spans the functional region (130) and the clamping region (120), is provided at least in some portions with at least one, in particular regular, microstructure (150).

The invention relates to a valve diaphragm.

Valve diaphragms for use in diaphragm valves are well known.

The problems of the prior art are solved by a valve diaphragm according to claim 1.

One aspect of the description relates to a valve diaphragm with a functional region, which is surrounded by an outer clamping region, wherein a wet-side surface, which spans the functional region and the clamping region, is provided at least in some portions with at least one, in particular regular, microstructure.

Providing the surface with a regular microstructure prevents microcracks since the mobility and stability of the wet-side surface is improved. This extends the service life of the valve diaphragm. Furthermore, maintenance intervals can be extended and cleanability benefits.

Furthermore, the microstructure can improve the hydrophobic property of the wet-side surface.

For example, it is advantageous that the at least one microstructure covers the clamping region and the functional region of the wet-side surface.

This example is in particular advantageous in conjunction with the raised, contiguous microwebs, i.e., for example, the honeycomb-shaped microstructure, since in particular contiguous raised webs are accompanied by a stabilizing effect and an increased sealing effect in interaction with a mating sealing portion.

Advantages are achieved in that the at least one microstructure is honeycomb-shaped or net-like.

The stability of the surface is advantageously improved.

For example, it is advantageous that the at least one microstructure comprises contiguous raised microwebs, which surround microdepressions.

This advantageously creates a common raised surface that is not interrupted by microdepressions, but rather is contiguous, and acts as a microbarrier. In particular in the clamping region and the sealing web region, differences in the sealing partner, such as scratches, can be compensated by the microstructure and by micromaterial flow.

For example, it is advantageous that an average maximum distance between two opposing microwebs of the associated microdepression of the microstructure is between 10 μm and 500 μm, in particular between 10 and 100 μm.

It is advantageous, for example, that the at least one microstructure comprises a contiguous, recessed microsurface, which surrounds microelevations.

It is advantageous that the functional region of the wet-side surface has a first contact angle with a first microstructure, and wherein the clamping region has a second contact angle, which is smaller than the first contact angle, with a second microstructure.

The functional region is thus more hydrophobic than the clamping portion. The process medium provided by the diaphragm thus adheres less strongly to the functional region. On the other hand, the smaller second contact angle has an advantageous effect for the clamping of the diaphragm between the wet-side surface of the clamping portion and the mating sealing portion of the valve body and thus has an advantageous effect on the tightness to the outside.

It is advantageous that the microdepressions or the at least one recessed microsurface are/is convex at least in some portions.

This not only improves mobility but also reduces flow resistance.

It is advantageous that a flexing region of the wet-side surface is arranged between the clamping region and a central region, through which the adjusting axis extends, and wherein the flexing region comprises the at least one microstructure.

The dynamically stressed flexing region thus benefits from the microstructure, which prevents cracks, in particular microcracks.

For example, it is advantageous that at least some of the raised microwebs in a clamping region of the wet-side surface follow a contour of the clamping region, in particular a circular shape.

This advantageously creates a barrier in order to provide a defined sealing edge when clamping the sealing region or clamping region. Furthermore, carryover of the process fluid into the sealing region is reduced.

Unevenness on the surface of a mating portion of the valve body associated with the clamping portion can advantageously be compensated as soon as the clamping portion is pressed onto the mating portion by the clamping force. In particular, under the clamping force, the structures on the wet-side surface of the clamping portion can flow and thus increase the tightness to the outside. The assembly is improved since the tightness to the outside can be reliably produced despite an enlarged assembly process window, for example an enlarged torque window. This allows the sealing force introduced into the clamping region to remain the same or even be reduced, while the width of the clamping portion can be reduced at the same time. This can improve the tightness of the diaphragm valve to the outside, increase the service life of the diaphragm and save installation space.

It is advantageous, for example, that at least some of the raised microwebs in a sealing web region of the wet-side surface extending through a feed axis follow a longitudinal contour of the sealing web region.

These microelevations advantageously improve the sealing effect in the web region, i.e., the sealing effect to the inside.

For example, it is advantageous that a rise of at least a number of the raised microwebs facing the adjusting axis is steeper than an associated rise facing away from the adjusting axis.

The barrier effect of the microwebs is advantageously improved.

For example, it is advantageous that a ratio of the average distance between adjacent microelevations and an average depth of the microstructure is between 0.2 and 0.9, in particular between 0.2 and 0.6.

This can advantageously increase a sealing effect and also improve a hydrophobic behavior of the surface.

For example, it is advantageous that a rise of at least a number of the microwebs facing the central longitudinal axis of the sealing web region is steeper than an associated rise facing away from the central longitudinal axis.

The barrier effect of the microwebs is advantageously improved.

For example, it is advantageous that the microelevations increase the contact angle of the wet-side surface.

The, in particular free-standing, microelevations advantageously increase the contact angle. The increased contact angle ensures better cleanability. Since even PFTE or PFA is subject to aging processes, the free-standing microelevations ensure that the desired contact angle can be maintained even over a longer period of time. The service life and period of application of the valve diaphragm are increased. Cleaning-related costs can be reduced. In particular, the media-contacting surface of the functional region benefits from this microstructure.

For example, it is advantageous that concentric subregions of the flexing region of the wet-side surface, in particular an intermediate region and edge regions of the flexing region surrounding the intermediate region, have at least two microstructures that are different from one another.

Tensile forces acting concentrically on the intermediate region act on the intermediate region. The edge regions surrounding the intermediate region, on the other hand, are subject to a rolling movement. Accordingly, differently designed microstructures support the respective movement or reinforce the respective wet-side surface.

### IN THE DRAWING

FIG. 1 shows a two-part valve diaphragm in a perspective view;

FIG. 2 is a schematic view of a wet-side surface of a valve diaphragm with a similar microstructure;

FIG. 3 shows schematic examples of microstructures in a clamping region of the diaphragm;

FIG. 4 is a schematic sectional view of the examples of microstructures of FIG. 3;

FIG. 5 shows schematic examples of microstructures in a sealing web region of the wet-side surface of the diaphragm;

FIG. 6 is a schematic sectional view of the examples of microstructures of FIG. 5;

FIG. 7 shows schematic examples of microstructures in a flexing region of the valve diaphragm; and

FIG. 8 shows a schematic view of the wet-side surface of an example of the valve diaphragm with different microstructures in the flexing region.

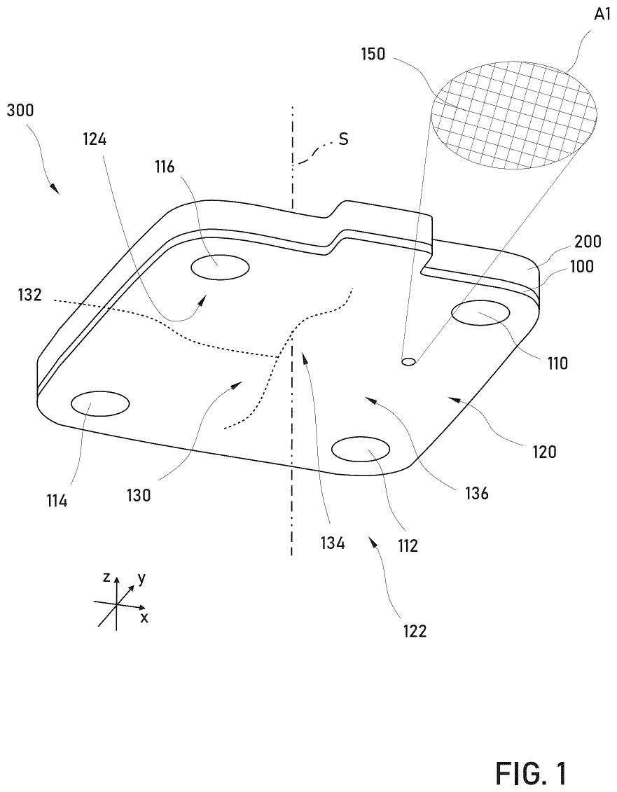

FIG. 1 is a perspective view of an exemplary two-part diaphragm 300 comprising a first diaphragm 100 facing a valve body of a diaphragm valve and a second diaphragm 200 facing a drive of the diaphragm valve. The second diaphragm 200 is, for example, made of an elastomer, and the first diaphragm 100 is made of a highly chemically resistant plastic material such as PFA or PTFE. Through-holes 110-116 lead through both valve diaphragms 100 and 200 and are used to pass fastening elements, such as stud bolts.

FIG. 1 is only an example. Of course, other embodiments are also conceivable, in particular diaphragms 100 with a substantially round outer contour and/or without the through-holes 110-116. One-part implementations, which, for example, only have the first diaphragm 100, are in particular also conceivable. In particular, the one-part diaphragm 100 can also be made of a different material, such as an elastomer material, such as EPDM.

The figure relates to the valve diaphragm 100 with a functional region 130, which is surrounded by an outer clamping region 120, wherein a wet-side surface 124, which spans the functional region 130 and the clamping region 120, is provided at least in some portions with at least one, in particular regular, microstructure 150.

The two-part diaphragm 300 is clamped in the lateral clamping region 120 between the valve body and the drive. The diaphragm 100 is clamped in the clamping region 120 between two components of the diaphragm valve and seals the diaphragm valve to the outside.

The functional region 130 of the valve diaphragm 100 is pressed onto the valve seat of the valve body in order to close the fluid channel formed by the valve body and a wet side 122 of the first diaphragm 100 for process fluid.

The valve diaphragm 100 comprises the wet-side surface 124 visible in FIG. 1 and a dry-side surface facing the drive. The wet-side surface 124 spans the functional region 130 and the clamping region 120. The movement is caused by a drive rod, which is moved by the drive along an adjusting axis S and presses, for example, with a pressure piece on the two-part diaphragm 300. Here, a sealing web 132 (indicated in the drawing) of the first diaphragm 100 presses on the valve seat. Of course, the sealing web in the sense of a visible elevation can also be omitted in other embodiments. By moving the first diaphragm 100 away from the valve seat, the fluid channel is opened.

The adjusting axis S extends, for example, perpendicularly to an imaginary diaphragm plane in the region of an imaginary center of the valve diaphragm 100. In the functional region 130, the diaphragm 100 comprises a static, central region 134, which is pressed on the wet side with the lateral portions of the sealing web region onto the valve seat in order to close the diaphragm valve. In addition to the pressure loads mentioned, the central region 134 is substantially moved along the adjusting axis S.

The diaphragm 100 comprises a dynamic region 136, which surrounds the central region 134 and is also referred to as the flexing region. The dynamic region 136 ensures through a movement that the central region 134 can be lifted from the valve seat and opens a cross-section for the flow of the process fluid. The movement of the dynamic region 136 corresponds to a concentric flexing movement. The diaphragm 100 comprises the static clamping region 120 enclosing the dynamic region 136.

A schematically enlarged detail Al shows the microstructure 150, which is present on the wet-side surface 124 and in the present case has raised elevations following a grid or net shape.

Microstructures can also be arranged on the dry side of the diaphragm 100, for example in order to prevent material wear.

The regularity of the microstructure 150 comprises, for example, a repetition of a microstructure pattern across a portion of the surface 124. In a further example, the regularity of the microstructure 150 means that the elevations and/or recesses are introduced into the surface according to a geometric design rule. The regularity of the microstructure 150 can thus be recognized by a microinspection of the wet-side surface 124.

For producing the microstructures 150, the production tool is, for example, pre-contoured accordingly.

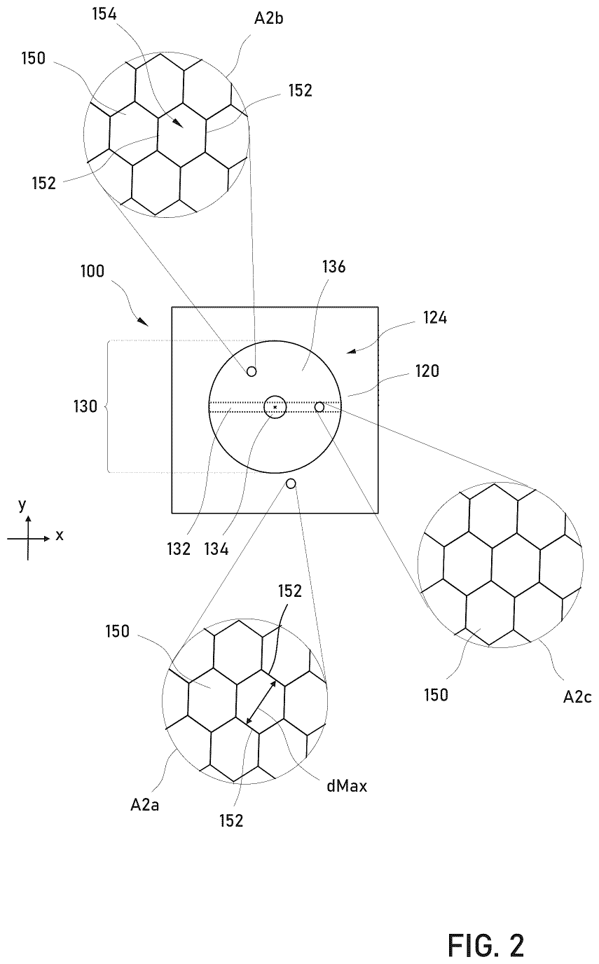

FIG. 2 shows the diaphragm 100 in a schematic view of its wet-side surface 124. For better clarity, the through-holes 110-116 are not shown.

It is shown that the at least one microstructure 150 covers the clamping region 120 and the functional region 130 of the wet-side surface 124. The at least one microstructure 150 is honeycomb-shaped and/or net-like.

The honeycomb-shaped microstructure 150 covers the clamping region 120, the flexing region 136 and the sealing web 132 according to the schematic enlarged details A2a, A2b, A2c. In particular, the entire wet-side surface 124 can be covered with the microstructure 150.

It is shown that the at least one microstructure 150 comprises contiguous raised microwebs 152, which surround hexagonal microdepressions 154.

An average maximum distance dMax between two opposing microwebs 152 of the associated microdepression 154 of the microstructure 150 is between 10 μm and 500 μm, in particular between 10 and 100 μm.

The distance dMax represents the maximum distance for an arrangement of directly opposing microwebs 152. Over a plurality of microweb pairs, the respective distance is averaged to obtain the distance dMax.

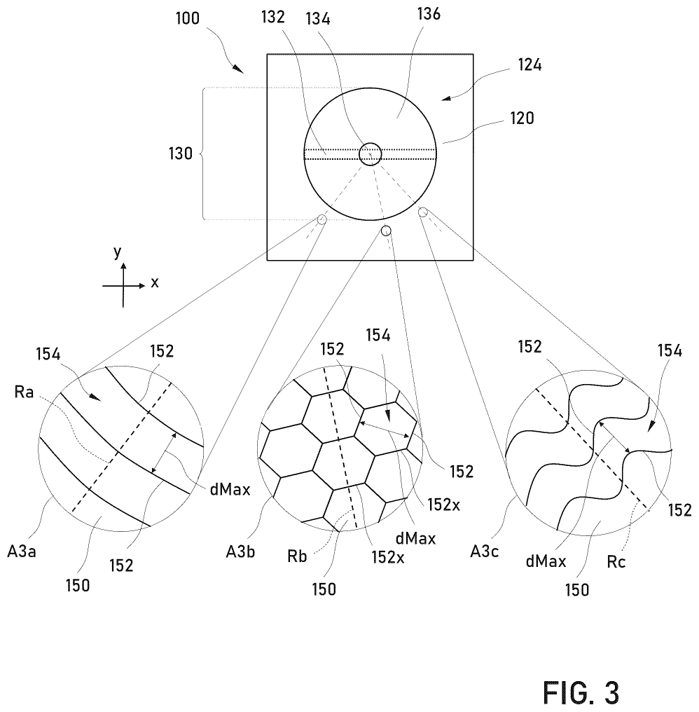

FIG. 3 shows schematically enlarged details A3a, A3b, A3c of different configurations of the clamping region 120 of the wet-side surface 124. The clamping region 120 surrounds the functional region 130 and thus has a circular inner edge. Depending on the configuration of the valve diaphragm 100, the clamping region 120 on the wet side is raised in a circular ring shape. The contour of the clamping region 120 is thus circular. The details A3a-c show the different examples of the microstructure 150 in the clamping region 120, with a respective radially extending axis Ra-c.

The examples show that at least some of the raised microwebs 152 in a clamping region 120 of the wet-side surface 124 follow a contour of the clamping region 120, in particular a circular shape. In particular, the microwebs 152 extend without interruption along the contour of the clamping region 120.

According to the detail A3a, the raised microwebs 152, with a microdepression 154 arranged between them in each case, extend in a groove shape and concentrically with the adjusting axis S. According to the detail A3b, raised microwebs 152x respectively extend perpendicularly to the radially extending axis Rb. According to the detail A3c, raised microwebs 152 extend in a wave shape in the circumferential direction, i.e., along the circular contour of the sealing region 120.

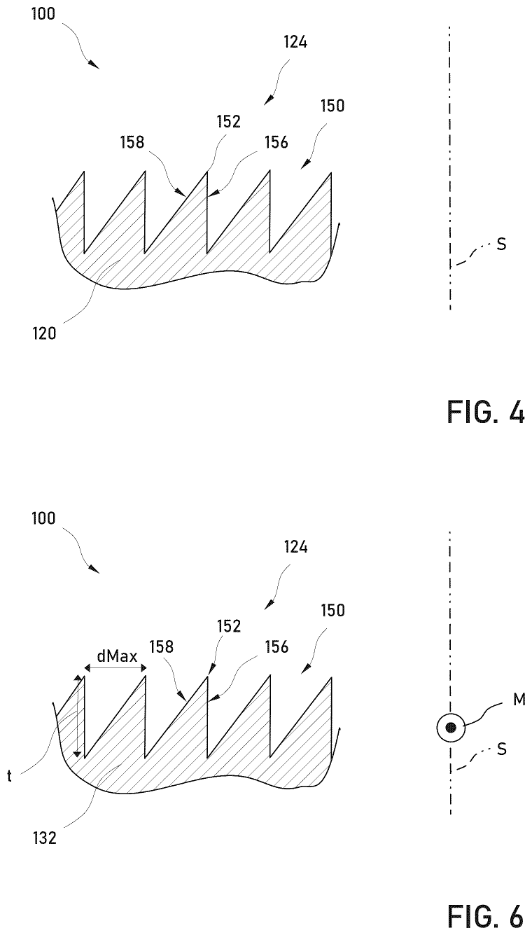

FIG. 4 shows a schematic section of the clamping region 120 of the valve diaphragm 100, the adjusting axis S lying in the continuation of the section. The wet-side surface 124 comprises the microstructure 150 shown in section.

A ratio of the average distance dMax between adjacent microelevations 164 and an average depth t of the microstructure 150 is between 0.2 and 0.9, in particular between 0.2 and 0.6. This can also be applied to the other microstructures 150 shown.

It is shown that a rise 156 of at least a number of the raised microwebs 152 facing the adjusting axis S is steeper than an associated rise 158 facing away from the adjusting axis S.

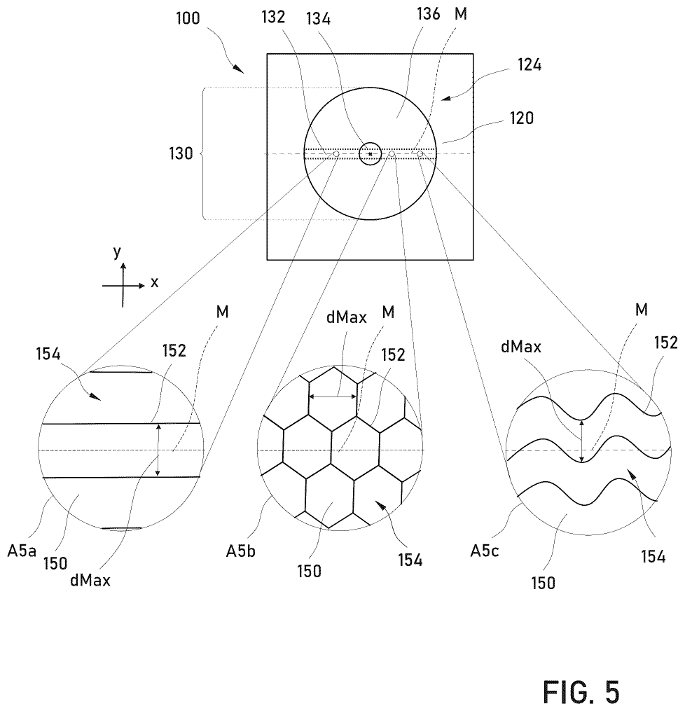

FIG. 5 shows schematically enlarged details A5a, A5b, A5c of different configurations of the sealing web region 132 of the wet-side surface 124.

It is shown that at least some of the raised microwebs 152 in a sealing web region 132 of the wet-side surface 124 extending through a feed axis S follow a longitudinal contour of the sealing web region 132.

The sealing web region 132 is arranged within the functional region 130 and extends along a central longitudinal axis M. Depending on the configuration of the valve diaphragm 100, the sealing web region 132 on the wet side is raised in a web shape or not raised. The contour of the sealing web region 132 is elongated. The details A3a-c show the different examples of the microstructure 150 in the sealing web region 132, with a respective central longitudinal axis M.

According to the detail A5a, the raised microwebs 152, with a microdepression 154 arranged between them in each case, extend in a groove shape and in parallel with the central longitudinal axis M. According to the detail A5b, contiguous raised microwebs 152 of the honeycomb structure follow a respective parallel axis of the central longitudinal axis M. According to the detail A5c, raised microwebs 152 extend in a wave shape and follow a parallel axis of the central longitudinal axis M.

FIG. 6 shows a schematic section of the sealing web region 132 of the valve diaphragm 100, the section comprising the adjusting axis S in a continuation. The wet-side surface 124 comprises the microstructure 150 shown in section.

For example, it is shown that a rise 156 of at least a number of the microwebs 152 facing the central longitudinal axis M of the sealing web region 132 is steeper than an associated rise 158 facing away from the central longitudinal axis M.

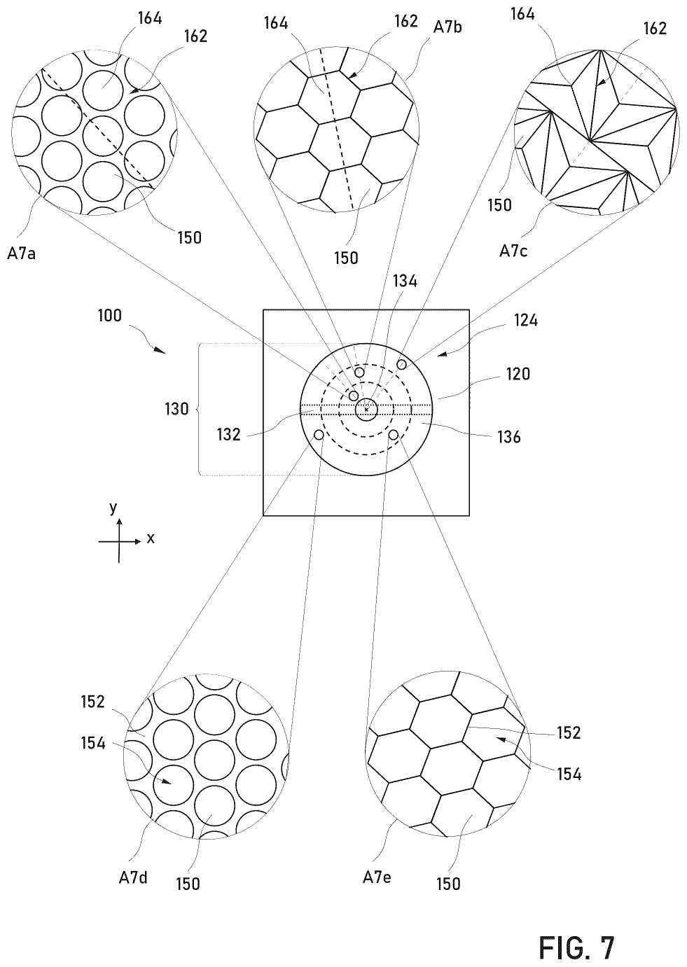

FIG. 7 shows schematically enlarged details A7a-e of various configurations of the dynamic region 136 of the wet-side surface 124, which dynamic region can also be referred to as a dynamically loaded region or flexing portion. The details A7a-e each show individual microstructures 150, which cover the dynamic region 136 at least in some portions.

For example, the enlargements A7a-c show that the at least one microstructure 150 comprises a contiguous recessed microsurface 162, which surrounds microelevations 164.

The microelevations 164 increase the contact angle of the wet-side surface 124 relative to a flat formation of the respective surface and in comparison to a contact angle mainly determined by the material.

In particular, the functional region 130 of the wet-side surface 124 has a first microstructure 150 with a first contact angle, wherein the clamping region 120 has a second contact angle, which is smaller than the first contact angle, with a second microstructure 150. In particular, the second contact angle is at least 20°, in particular at least 40°, in particular at least 60° smaller than the first contact angle. The contact angle relates to the effect of the corresponding surface with water.

According to the detail A7a, dome-like microelevations 164 rise from the contiguous microsurface 162. According to the detail A7b, contiguous recessed microwebs in the form of a contiguous microsurface 162 follow a honeycomb structure. Microelevations 164 rise from the microsurface 162 and are separated from one another by the microsurface 162. According to the detail A7c, tetrahedral microelevations 164 extend from recessed microdepressions, which are collectively referred to as the microsurface 162.

The microdepressions 154 are—or the at least one recessed microsurface 162 is—convex at least in some portions.

In contrast to the details Ala and A7b, the details A7d and Ale essentially show an inverted pattern of the microstructures 150. In the schematically shown detail A7d, there is thus a contiguous surface in the sense of raised microwebs 152, into which convex or dome-like microrecesses 154 are introduced. The schematically illustrated detail A7e shows a honeycomb-shaped microstructure 150, in which interconnected microwebs 152 form the honeycomb shape and microrecesses 154 are introduced between the microwebs.

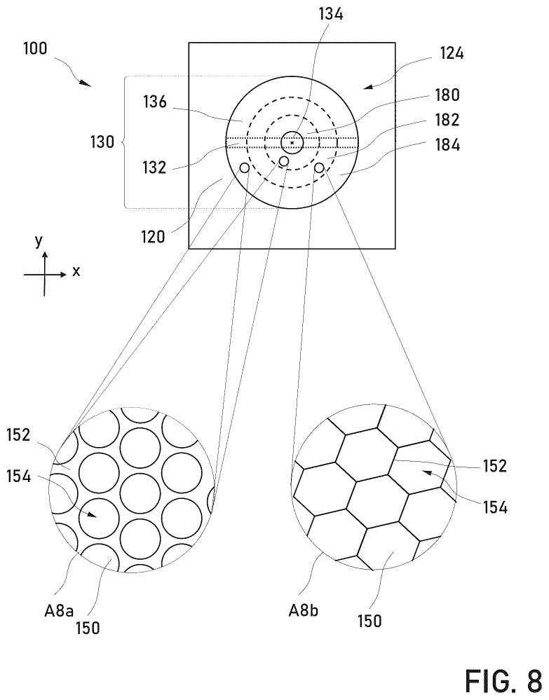

In contrast to FIG. 7, FIG. 8 shows that the wet-side surface 124 in the dynamic region 136 is provided with different microstructures 150, at least outside the sealing web region 132.

For example, it is shown that the flexing region 136 of the wet-side surface 124 is arranged between the clamping region 120 and the central region 134, through which the adjusting axis S extends, wherein the flexing region 136 comprises the at least one microstructure 150.

It is shown that concentric subregions 180, 182, 184 of the flexing region 136 of the wet-side surface 124, in particular an intermediate region 182 and edge regions 180, 184 of the flexing region 136 surrounding the intermediate region 182, have at least two microstructures 150 that are different from one another.

For example, the intermediate region 182 comprises a microstructure 150, such as a honeycomb shape, that primarily reinforces the surface, and the edge regions 180, 184 comprise microstructures 150 that primarily have a hydrophobic effect or support the flexing movement.

The schematically illustrated, enlarged detail A8a shows the microstructure 150 in the edge regions 180 and 184, with concave depressions, which are surrounded by round edges in each case and by the raised webs 152. The detail A8b, on the other hand, shows a honeycomb-shaped microstructure 150 for the intermediate region 182 or the wet-side surface 124 of the intermediate region 182.

1-17. (canceled)

18. A valve diaphragm with a functional region, which is surrounded by an outer clamping region, wherein a wet-side surface, which spans the functional region and the clamping region, is provided at least in some portions with at least one regular microstructure.

19. The valve diaphragm according to claim 18, wherein the at least one microstructure covers the clamping region and the functional region of the wet-side surface.

20. The valve diaphragm according to claim 18, wherein the at least one microstructure is honeycomb-shaped or net-like.

21. The valve diaphragm according to claim 18, wherein the at least one microstructure comprises contiguous raised microwebs, which surround microdepressions.

22. The valve diaphragm according to claim 21, wherein at least some of the raised microwebs in a clamping region of the wet-side surface follow a contour of the clamping region, wherein the contour has a circular shape.

23. The valve diaphragm according to claim 18, wherein a ratio of the average distance (dMax) between adjacent microelevations or adjacent microwebs and an average depth (t) of the microstructure is between 0.2 and 0.6.

24. The valve diaphragm according to claim 22, wherein a rise of at least a number of the raised microwebs facing the adjusting axis(S) is steeper than an associated rise facing away from the adjusting axis(S).

25. The valve diaphragm according to claim 21, wherein at least some of the raised microwebs in a sealing web region of the wet-side surface extending through a feed axis(S) follow a longitudinal contour of the sealing web region.

26. The valve diaphragm according to claim 25, wherein a rise of at least a number of the microwebs facing the central longitudinal axis (M) of the sealing web region is steeper than an associated rise facing away from the central longitudinal axis (M).

27. The valve diaphragm according to claim 18, wherein an average maximum distance (dMax) between two opposing microwebs of the associated microdepression of the microstructure is between 10 and 100 μm.

28. The valve diaphragm according to claim 18, wherein the at least one microstructure comprises a contiguous recessed microsurface, which surrounds microelevations.

29. The valve diaphragm according to claim 28, wherein the microelevations increase the contact angle of the wet-side surface.

30. The valve diaphragm according to claim 18, wherein the functional region of the wet-side surface has a first contact angle with a first microstructure, and wherein the clamping region with a second microstructure has a second contact angle, which is smaller than the first contact angle.

31. The valve diaphragm according to claim 18, wherein the microdepressions or the at least one recessed microsurface are/is convex at least in some portions.

32. The valve diaphragm according to claim 18, wherein a flexing region of the wet-side surface is arranged between the clamping region and a central region, through which the adjusting axis(S) extends, and wherein the flexing region comprises the at least one microstructure.

33. The valve diaphragm according to claim 32, wherein concentric subregions of the flexing region of the wet-side surface, in particular an intermediate region and edge regions of the flexing region which surround the intermediate region, have at least two microstructures that are different from one another.

34. A diaphragm valve comprising the valve diaphragm of claim 18.
